(19) United States
(12) Patent Application Publication
(10) Pub. No.: US 2012/0020184 A1
(43) Pub. Date: Jan. 26, 2012

(54) USING A DISTRIBUTED OPTICAL ACOUSTIC SENSOR TO POSITION AN OBJECT

(76) Inventors: Colin Wilson, Tolworth (GB); Johan O. A. Robertsson, Grantchester (GB); Julian Edward (Ed) Kragh, Finchingfield (GB); Everhard Muyzert, Girton (GB); Kenneth E. Welker, Nesoya (NO); Douglas Miller, Boston, MA (US)

(21) Appl. No.: 12/843,416

(22) Filed: Jul. 26, 2010

(51) Int. Cl. G01V 1/38

(52) U.S. Cl. 367/16; 367/19

(57) ABSTRACT

A distributed optical acoustic sensor is provided along a structure in a body of water. The distributed optical acoustic sensor is used to detect acoustic waves generated by at least one acoustic source for positioning of at least one object in relation to the structure.

### BACKGROUND

Subterranean surveying for determining the content of a subterranean structure can be performed in a marine environment. In performing such marine subterranean surveying, sensors (such as seismic sensors or electromagnetic sensors) can be towed by a structure (sometimes referred to as a streamer) through a body of water. Alternatively, sensors can be arranged on a cable placed on a sea floor.

Source signals, such as seismic signals or electromagnetic signals, are generated by one or more signal sources for propagation into the subterranean structure. The propagated signals are reflected from or otherwise affected by the subterranean structure, where the reflected or affected signals are detected by the sensors on the streamer or cable.

In a survey arrangement, positions of various components of a survey spread, including the streamer or cable, can be difficult to accurately ascertain.

### SUMMARY

In general, according to an embodiment, a method includes providing a distributed optical acoustic sensor along a structure in a body of water, and using the optical acoustic sensor to detect acoustic waves generated by at least one acoustic source for positioning at least one object in relation to the structure.

Other or alternative features will become apparent from the following description, from the drawings, and from the claims.

### BRIEF DESCRIPTION OF THE DRAWINGS

Some embodiments of the invention are described with respect to the following figures:

FIGS. 1 and 2 are schematic diagrams of example arrangements that include a distributed optical acoustic sensor mounted to a structure placed in a body of water, in accordance with some embodiments;

FIG. 3 is a schematic diagram of an interrogation system for use with a distributed optical acoustic sensor according to some embodiments;

FIG. 4 is a flow diagram of a process of positioning at least one object in relation to a structure in a body of water, according to some embodiments;

FIG. 5 is a block diagram of an example control system incorporating components according to some embodiments.

### DETAILED DESCRIPTION

Traditionally, a marine survey arrangement for surveying the content of a subterranean structure involves towing one or more streamers through a body of water, where each streamer has sensors for detecting signals reflected from or affected by the subterranean structure. Alternatively, sensors can be deployed on a cable that is positioned on a bottom surface of a body of water (e.g., a sea floor). Elements of interest in the subterranean structure include hydrocarbon reservoirs, fresh water aquifers, gas injection zones, and so forth.

For seismic surveying, the sensors that are part of the streamer or cable are seismic sensors, such as hydrophones, accelerometers, and so forth. For electromagnetic (EM) surveying, the sensors can be EM receivers.

In a marine environment, a structure in the body of water can be subjected to various forces (caused by water currents, movement of marine vessels, and other factors) that can make determination of exact positions of the components of the survey arrangement difficult. In one example conventional arrangement, a streamer is provided with acoustic pingers that are arranged along the length of the streamer. The acoustic pingers are able to emit relatively high-frequency pings that are substantially above the maximum frequency of interest for seismic applications (which are typically in the kilohertz range). During a seismic survey, the acoustic pingers are activated regularly, and the high-frequency acoustic signals are picked up by designated seismic sensors (e.g., hydrophones) along the streamer or in other structures that are part of the seismic survey spread. A “survey spread” refers to equipment used for performing the marine subterranean survey, where the equipment can include the streamer or cable carrying sensors, as well as other equipment such as one or more source arrays (that carry signal sources), navigation equipment for navigating components of the survey spread, and so forth.

The time of arrival of an acoustic signal at a designated seismic sensors is determined. The travel time of the acoustic signal between an acoustic pinger and the receiving seismic sensor can be determined. The travel time data can be used to solve for positions of various portions of the seismic survey spread, since the velocity of sound in water can be determined by various techniques, and points in the spread such as the front and/or tail (or other location) of any spread can be determined using a global positioning system (GPS) receiver.

A survey spread can have multiple streamers, where each of the streamers can have acoustic pingers. Positioning a particular streamer can be accomplished by receiving signals from acoustic pingers on streamers that are the two sides of the particular streamer.

Using the foregoing technique for positioning a marine survey spread can be somewhat complicated, since the same recording elements are used for recording both seismic data and acoustic pings. In addition, the recording of high-frequency acoustic pings on hydrophones may not be possible due to relatively high bandwidth requirements for communications.

In accordance with some embodiments, instead of using traditional acoustic sensors such as hydrophones for detecting acoustic waves generated by one or more acoustic sources for positioning a marine survey spread, a distributed optical acoustic sensor is used instead. The “distributed optical acoustic sensor” refers to a sensor that extends along some predefined length with respect to a structure that is located in a body of water. In some embodiments, the distributed optical acoustic sensor includes one or more optical fibers.

An optical source is used to generate optical signals that are emitted into an optical fiber in the distributed optical acoustic sensor, with backscattered light responsive to the emitted optical signals being detected by an optical receiver. Certain parts of the optical fiber may be affected by acoustic waves, such as acoustic waves generated by the acoustic pingers that are part of a streamer, or by other acoustic sources. The acoustic waves cause strain to be applied on portions of the optical fiber, which affect the backscattered optical signals that are reflected back to the optical receiver.

Analysis of the received backscattered optical signals allows for positioning of one or more objects of interest in relation to a structure carrying the distributed optical acoustic sensor. For example, the one or more objects of interest can include one or more portions of a structure that carries survey sensors. Such a structure can include a streamer towed through a body of water, or a seabed cable positioned on the sea floor.

Alternatively, the one or more objects of interest can also include external objects that may intrude upon the marine survey spread. For example, the external object that may intrude upon the marine survey spread may be a marine vessel or a large fish or mammal (or other living being). A marine vessel or large living being may cause damage to portions of the marine survey spread, such that it would be useful to detect possible collision between the marine survey spread and the external object.

Positioning of one or more objects of interest using some embodiments can also be applied in the context of passive acoustic monitoring. Passive acoustic monitoring is used for protecting marine living beings from injury caused by survey activities. Passive acoustic monitoring using some embodiments of the inventions can be used to determine whether a marine living being is nearby, such that survey activities can be slowed down or even stopped to protect such marine living beings. Some countries have passed legislation that mandate steps to ensure that marine living beings are not injured or damaged.

The distributed optical acoustic sensor can be employed in a marine survey arrangement that performs either a seismic survey or an electromagnetic survey. Alternatively, the distributed optical acoustic sensor can be used in other marine contexts in which it may be useful to position portions of equipment in a body of water.

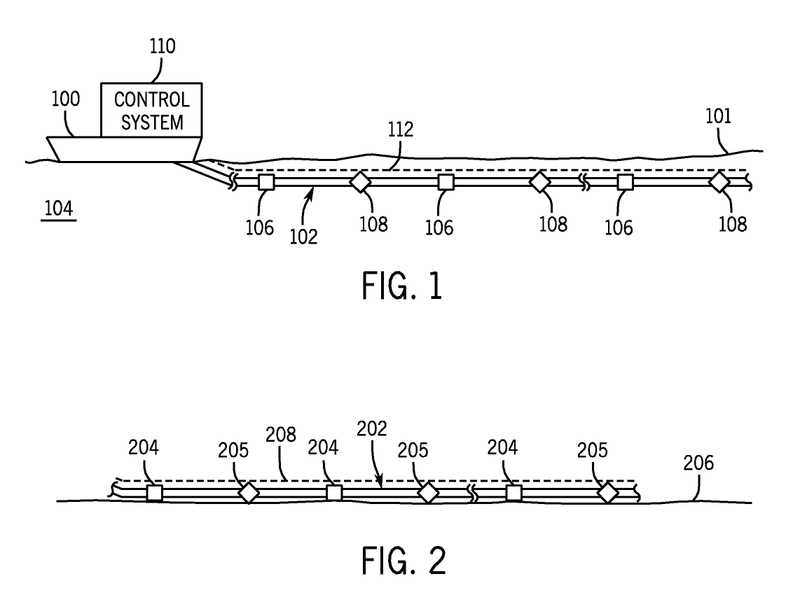

FIG. 1 illustrates a marine survey arrangement that has a marine vessel 100 (on a water surface 101) that tows a streamer 102 through a body of water 104. The streamer 102 has survey sensors 106 (e.g., seismic sensors or EM sensors). In addition, the streamer 102 includes one or more acoustic pingers 108 mounted at various points along the streamer 102. In a different embodiment, instead of using multiple acoustic pingers, just a single acoustic pinger 108 can be provided on the streamer 102. Although just one streamer 102 is depicted, note that a survey arrangement can include multiple streamers each including acoustic pingers.

As yet other alternatives, acoustic pingers or other acoustic sources can be mounted elsewhere, such as on the marine vessel 100, on a platform, on a buoy, in an aircraft that is in the air, and so forth.

The marine vessel 100 also has a control system 110 that is electrically coupled to the streamer 102. The control system 110 can receive signals collected by the survey sensors 106. Also, the control system 110 can control activation of the acoustic pingers 108.

In accordance with some embodiments, a distributed optical acoustic sensor 112 (shown as a dashed line) is arranged along the length of (or part of the length of) the streamer 102. The distributed optical acoustic sensor 112 can be externally attached or otherwise mounted to the streamer 102, or alternatively, the distributed optical acoustic sensor 112 can be provided inside the external housing of the streamer 102. The distributed optical acoustic sensor 112 can be attached to the streamer 102 using an adhesive or some other attachment mechanism.

In some embodiments, the distributed optical acoustic sensor 112 can include one (or multiple) optical fibers that extend along the length of the distributed optical acoustic sensor 112. The control system 110 includes an optical source to emit optical signals into the optical fiber of the distributed optical acoustic sensor 112. The control system 110 also includes a receiver to receive backscattered optical signals from the optical fiber, where the backscattered signals are in response to the optical signals emitted by the optical source. The control system 110 can also include a processor to analyze the backscattered signals for the purpose of positioning one or more objects of interest in relation to the streamer 102, where the objects of interest can be one or more portions of the streamer 102, or an external object that may collide with the streamer 102.

When trying to position an external object such as another marine vessel or a large living being, the external object may provide the acoustic source, such as in terms of noise produced by the external object when moving through the body of water 104.

In some implementations, the optical fiber (or multiple optical fibers) of the distributed optical acoustic sensor 112 can be generally encased in a protective layer. For example, the optical fiber may be disposed within a control line strapped to the outside of the streamer 102. Alternatively, the protective layer can be the streamer housing itself if the distributed optical acoustic sensor 102 is located inside the streamer housing.

In some embodiments, monitoring of acoustic waves by the distributed optical acoustic sensor 112 can be based on coherent Rayleigh backscatter in which a pulse of coherent light is launched into the optical fiber and returned (backscattered) light is analyzed. When the optical fiber is disturbed by an acoustic wave, the modulation of the backscattered optical signal is varied in the vicinity of the disturbance.

In some embodiments, rather than employ a fully distributed optical sensing fiber, an array of discrete reflectors can be used instead by inserting such discrete reflectors into the optical fiber. For example, the reflectors may be Bragg reflectors.

FIG. 2 illustrates an alternative arrangement in which a seabed cable 202 having survey sensors 204 are arranged on a sea floor 206. In accordance with some embodiments, a distributed optical acoustic sensor 208 is attached to (or embedded inside) the seabed cable 202. Although not depicted, the seabed cable 202 and distributed optical acoustic sensor 208 are coupled to a control system similar to the control system 110 of FIG. 1. The seabed cable 202 can also include acoustic pingers 205 along the length of the cable 202. Alternatively, the acoustic pingers or other acoustic sources can be positioned elsewhere.

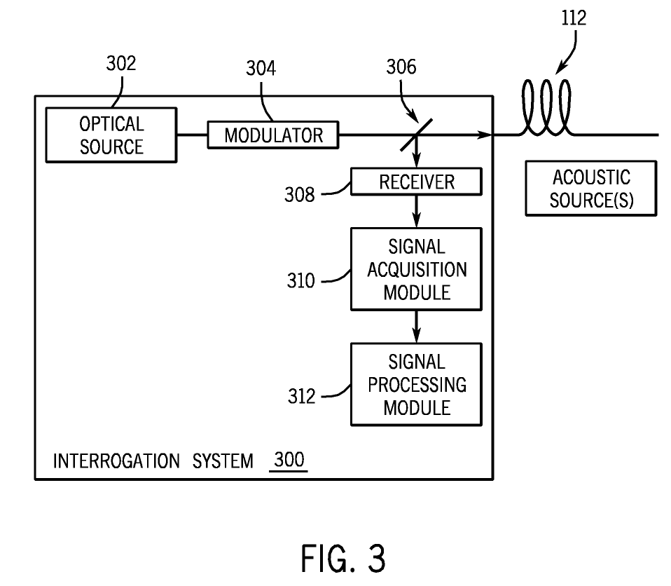

FIG. 3 illustrates an example embodiment of an interrogation system 300 that can be used with an optical fiber of the distributed optical acoustic sensor 112. The interrogation system 300 can be part of the control system 110 of FIG. 1, for example. The interrogation system 300 includes an optical source 302 that generates an optical signal, such as an optical pulse, for interrogating the optical fiber in the distributed optical acoustic sensor 112. In some embodiment, the optical source 302 may include a narrow band laser source that is followed by a modulator 304 selects short pulses from the output of the laser. Optionally, an optical amplifier may be used to boost the peak power of the pulses launched into the optical fiber. The amplifier may be placed after the modulator 302, and the amplifier may also be followed by a filter for filtering in the frequency domain (e.g., bandpass filter) and/or in the time domain.

The pulses emitted by the optical source 302 are launched into the optical fiber through a directional coupler 306, which separates outgoing and returning optical signals and directs the returning (backscattered) signals to an optical receiver 308. The directional coupler 306 may be a beam splitter, a fiber-optic coupler, a circulator, or some other optical device.

The backscattered optical signals returned from the optical fiber of the distributed optical acoustic sensor in response to interrogating pulses may be detected and converted to an electrical signal at the receiver 308. This electrical signal may be acquired by a signal acquisition module 310 (e.g., an analog-to-digital converter) and then transferred as data representing the backscattered signals to a signal processing module 312. The signal processing module 312 can include a processor such as a microprocessor, microcontroller, digital signal processor, computer, and so forth. The signal processing module 312 analyzes the waveforms received to determine, at each location along the optical fiber, where the signal is changing. The signal processing module 312 is able to interpret the change in terms of acoustic waves modulating the backscatter return of the optical fiber.

When an optical fiber portion is disturbed by acoustic waves, the optical fiber portion is strained by the acoustic waves. A strain on the optical fiber portion changes the relative position between the scattering centers by simple elongation of the optical fiber portion. The strain also changes the refractive index of the glass of the optical fiber portion. Both these effects alter the relative phase of the light scattered from each scattering center.

In alternative implementations, the optical fiber can be manufactured with optical gratings or other types of reflectors that can cause backscatter of light whose characteristics are affected by presence of acoustic signals.

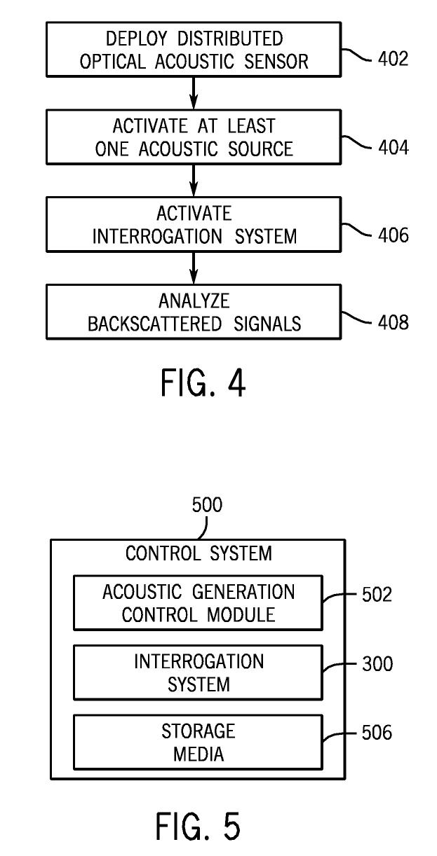

FIG. 4 is a flow diagram of a process of performing positioning of an object in accordance with an embodiment. A distributed optical acoustic sensor, such as sensor 112 or 208 in FIG. 1 or 2, respectively, is deployed (at 402) in a marine environment. For example, the distributed optical acoustic sensor can be arranged along an elongate structure such as a streamer or a seabed cable, or other structure that is part of a survey spread. As yet another alternative,

At least one acoustic source can be activated (at 404), where the at least one acoustic source can include acoustic pingers, and/or some other acoustic source(s). For implementations to detect intrusion of an external object such as a marine vessel or a living being, the acoustic source can be the external object itself.

The interrogation system 300 (FIG. 3) is activated (at 406), which causes optical signals to be emitted into distributed optical acoustic sensor, which cause backscattered optical signals to be received by the interrogation system 300. The backscattered signals received by the interrogation system 300 are analyzed (at 408) to perform positioning of various parts or the entirety of the marine survey spread, or to perform positioning of an external object.

FIG. 5 is a block diagram of portions of a control system 500, according to an embodiment. The control system 500 can be similar to the control system 110 shown in FIG. 1.

The control system 500 includes an acoustic generation control module 502 to cause activation of one or more acoustic sources, such as the pingers 108 or 205 of FIG. 1 or 2. In addition, the control system 500 includes the interrogation system 300 as shown in FIG. 3. The control system 500 can include storage media 506 to store data associated with performing positioning of the marine survey spread or an external object.

The positioning of portions of a survey spread or of an external object or of any other equipment can be accomplished based on analysis by software, such as software that is in the signal processing module 312 of the interrogation system 300.

Instructions of the software can be loaded for execution on a processor, which can include one or more microprocessors, microcontrollers, processor modules or subsystems (including one or more microprocessors or microcontrollers), programmable integrated circuits, programmable gate arrays, or other control or computing devices. As used here, a “processor” can refer to a single component or to plural components (e.g., one CPU or multiple CPUs, or one computer or multiple computers).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method comprising:
providing a distributed optical acoustic sensor along a structure in a body of water; and
using the distributed optical acoustic sensor to detect acoustic waves generated by at least one acoustic source for positioning of at least one object in relation to the structure.

2. The method of claim 1, wherein the at least one object includes one or more portions of the structure, and wherein using the distributed optical acoustic sensor comprises receiving backscattered optical signals from the distributed optical acoustic sensor to determine one or more positions of the one or more portions of the structure.

3. The method of claim 2, wherein the structure is a marine streamer having sensors to perform subterranean surveying, and wherein receiving the backscattered optical signals comprises receiving the backscattered optical signals for positioning the streamer.

4. The method of claim 1, wherein the at least one acoustic source is mounted on the structure.

5. The method of claim 1, wherein the at least one object includes an external object separate from the structure, and wherein using the optical acoustic sensor comprises using the distributed optical acoustic sensor to detect proximity of the external object to the structure.

6. The method of claim 5, wherein the external object is one of a marine vessel and a living being.

7. The method of claim 5, wherein positioning the external object is performed as part of passive acoustic monitoring.

8. The method of claim 1, wherein the at least one acoustic source includes acoustic pingers along the structure, the method further comprises activating the acoustic pingers to generate the acoustic waves.

9. The method of claim 1, wherein providing the distributed optical acoustic sensor comprises providing the distributed optical acoustic sensor that has an optical fiber, wherein the optical fiber is coupled to an optical source that emits optical signals into the optical fiber, and the optical fiber is coupled to a receiver to receive backscattered optical signals responsive to the optical signals emitted by the optical source.

10. The method of claim 9, further comprising:
analyzing the backscattered optical signals to perform positioning of the at least one object, wherein the backscattered optical signals are affected by strain on one or more portions of the optical fiber caused by the acoustic waves.

11. A system comprising:
at least one acoustic source to generate acoustic waves;
an elongate structure for deployment in a body of water; and
a distributed optical acoustic sensor arranged along the elongate structure, the distributed optical acoustic sensor configured to produce optical backscattered signals responsive to the acoustic waves for positioning at least one object in relation to the structure.

12. The system of claim 11, wherein the distributed optical acoustic sensor comprises at least one optical fiber to receive optical signals launched from an optical source and to return the optical backscattered signals in response to the launched optical signals.

13. The system of claim 12, further comprising:
a receiver to receive the optical backscattered signals; and
a signal processing module configured to analyze data representing the optical backscattered signals to perform positioning of the at least one object.

14. The system of claim 11, wherein the at least one source includes one or more acoustic pingers along the structure.

15. The system of claim 11, wherein the at least one source is positioned on a component separate from the structure, wherein the component includes one of a marine vessel, a platform, a buoy, and an aircraft.

16. The system of claim 11, wherein the at least one object is an external object separate from the structure, and wherein the at least one source is part of the external object.

17. The system of claim 11, wherein the structure has survey sensors configured to receive signals reflected from or affected by a subterranean structure.

18. The system of claim 17, wherein the survey sensors comprise seismic sensors or electromagnetic sensors.

19. An article comprising at least one computer-readable storage medium storing instructions that upon execution cause a processor to:
receive data representative of optical backscattered signals from a distributed optical acoustic sensor, wherein the distributed optical acoustic sensor is arranged along a structure deployed in a body of water, and wherein the optical backscattered signals are affected by acoustic waves impinging on the distributed optical acoustic sensor; and
analyze the data to determine one or more positions of at least one object of interest in relation to the structure.

20. The article of claim 19, wherein the at least one object of interest includes portions of the structure or an external object that may collide with the structure.
